(19) United States
(12) Patent Application Publication
(10) Pub. No.: US 2010/0098806 A1
(43) Pub. Date: Apr. 22, 2010

(54) Compositions and Methods of Dehydrated Food Fortification

(75) Inventor: Jeff Van Drunen, South Holland, IL (US)

Correspondence Address: FISH & ASSOCIATES, PC;ROBERT D. FISH, 2603 Main Street, Suite 1000, Irvine, CA, 92614-6232, US

(73) Assignee: VDF FUTURECEUTICALS, INC., Momence, IL (US)

(21) Appl. No.: 12/530,939

(22) PCT Filed: Mar. 13, 2008
(86) PCT No.: PCT/US08/03391

§ 371 Date: Dec. 3, 2009

Related U.S. Application Data
(60) Provisional application No. 60/894,523, filed on Mar. 13, 2007.

(51) Int. Cl. A23L 1/28; A23L 1/212; A23L 1/29; A23P 1/08

(52) U.S. Cl. 426/61

(57) ABSTRACT

A dehydrated and unprocessed food item (e.g., grain, fruit, vegetable, or portion thereof) is at least partially coated with a non-aqueous and nutritionally acceptable solvent that comprises a probiotic organism such that the fortified food item has a total probiotic content of at least 104 to 105 cfu/gram. Shelf life of such compositions is remarkably long while maintaining relatively high cfu count, and taste and flavor are remarkably preserved, even over extended periods.

This application claims priority to our copending US provisional application with the Ser. No. 60/894523, which was filed Mar. 13, 2007.

### FIELD OF THE INVENTION

The field of the invention is dehydrated food, especially as it relates to dehydrated food that is fortified with probiotics.

### BACKGROUND OF THE INVENTION

Probiotics fortified food has become an increasingly desirable article of commerce and numerous formulations are known in the art. However, stability and viability of probiotics are often significantly compromised by, for example, heat-intensive steps in the food preparation, air oxidation, high water content of the food preparation, and/or storage.

To improve the shelf life of probiotics-containing food, several approaches have been undertaken. However, most of those known approaches add significant cost, complicate food preparation, and/or leave other desirable factors unaddressed. For example, freeze-dried foods can be prepared from a mixture of probiotic bacteria and a milk or soy product as described in WO 01/62099. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

However, such products typically require molding or other shaping of the wet product prior to freeze-drying and thus will not work with largely unprocessed food items (e.g., fruit or vegetables). Alternatively, probiotic bacteria may be prepared in a protein/carbohydrate formulation to form a Maillard reaction product and thus may improve stability as described in WO 2005/030229, which is also incorporated by reference herein. While such formulations significantly increase shelf-life of the probiotic composition, production costs are typically relatively high.

Alternatively, fresh non-dried biomass from a probiotic fermentation can be applied to certain food stuffs as described in U.S. Pat. App. No. 2004/0115308. Here, extruded, cooked and otherwise prepared food products (e.g., puffed cereals) are coated with the probiotic culture and not subjected to a high-temperature drying process, wherein the cereals absorb the liquid from the fermentation to dryness. Similarly, as described in U.S. Pat. No. 6,022,568, ice cream is coated with a milk-based low-fat suspension that includes the probiotics. Freezing of the film will then keep the bacteria in place.

In further known approaches, probiotics may be packaged in a nitrogen-purged capsule to avoid oxidative degradation as described in U.S. Pat. App. No. 2006/0159745, also incorporated by reference herein. However, such packaging requires a relatively complicated process and is typically not applicable to food items. In a conceptually more simple approach, as described in WO 02/060510, a lipid phase is prepared in which probiotics are disposed that is then supplied to an end user in a suitable container as liquid formulation. Alternatively, micronutrients (and particularly iron) and probiotics are also known to be formulated in a powder, which is provided in a sachet to a user that can then sprinkle the powder over food as described in WO 01/15714, incorporated by reference herein. In still further known methods, probiotics are delivered in a lozenge having high sugar content and a humectant. Such formulations typically have 5-25% of water as described in U.S. Pat. App. No. 2006/0067922, which is also incorporated by reference herein. Therefore, while the above approaches simplify delivery of probiotics to at least some degree, various disadvantages nevertheless remain. Most significantly, currently known methods and compositions are typically not suitable in a process to produce large quantities of probiotic-fortified dehydrated foods such as fruit and/or vegetables and/ or low moisture components of a breakfast cereal or bar as precursors.

Therefore, while numerous methods of food processing are known in the art, all or almost all of them suffer from one or more disadvantages. Consequently, there is still a need to provide improved composition and methods for fortified dehydrated food.

### SUMMARY OF THE INVENTION

The present invention provides compositions and methods in which a dehydrated food item, and most preferably a unprocessed grain, fruit, or vegetable, or a portion thereof is coated with a non-aqueous composition that includes probiotic organisms to so fortify the dehydrated food item. While other options are also deemed suitable, it is particularly preferred that the food item is a freeze-dried.

In especially preferred aspects, a dehydrated and unprocessed grain, fruit, or vegetable, or a portion thereof, is at least partially coated with a non-aqueous and nutritionally acceptable solvent that includes probiotic organisms at a concentration sufficient to achieve a total probiotic content of at least 10⁴ cfu/gram and more typically at least 10⁶ cfu/gram of the fruit or vegetable, or portion thereof. Among other suitable choices, it is especially preferred that the dehydrated fruit is an optionally comminuted berry or tree fruit, that the vegetable is optionally comminuted broccoli, carrot, celery, or cauliflower, and that the grain is an optionally comminuted or rolled oat, barley, or wheat. Especially preferred probiotic organisms include L. Acidophilus, L. Bulgaricus, S. Thermophilus, and B. Bifidum.

In further preferred aspects of the inventive subject matter, the grain, fruit, vegetable, or portion thereof is dehydrated to have a water content of equal or less than 5 wt % or to have a water activity of equal or less than 0.65, and/or it is further preferred that the probiotic organism is also dehydrated. In such case, it is also contemplated that at least a portion of the fermentation medium (e.g., milk product) may also be dehydrated and added to the non-aqueous solvent. Especially preferred nutritionally acceptable solvent is selected from the group consisting of a vegetable oil, glycerol, a glycol, an omega-3 oil, and a fruit seed oil.

Therefore, a dehydrated grain product is also contemplated that is at least partially coated with a non-aqueous and nutritionally acceptable solvent that comprises a probiotic organism at a concentration sufficient to achieve a total probiotic content of at least 10⁵ cfu/gram of the grain product, wherein the grain product is dehydrated to have a water content of equal or less than 5 wt % or to have a water activity of equal or less than 0.65. Most preferably, the nutritionally acceptable solvent in such products is a vegetable oil, glycerol, a glycol, an omega-3 oil, and/or a fruit seed oil, and the probiotic organism is L. Acidophilus, L. Bulgaricus, S. Thermophilus, and/or B. Bifidum.

Therefore, viewed from a different perspective, a method is contemplated in which in one step an unprocessed grain, fruit, or vegetable, or portion thereof is provided and dehydrated to a water content of equal or less than 5 wt % or to a water activity of equal or less than 0.65 (or provided as a dehydrated food item). In another step of such methods, a composition is dehydrated that includes a probiotic organism and the so dehydrated probiotic organism is then combined with a non-aqueous and nutritionally acceptable solvent to thereby form a coating suspension. In yet another step, a food item (e.g., grain, fruit, or vegetable, or portion thereof) is then coated with the coating suspension, typically to a final probiotic concentration of between 10⁴ cfu/gram to 10⁹ cfu/gram.

In especially preferred methods, the nutritionally acceptable solvent is a vegetable oil, glycerol, a glycol, an omega-3 oil, and/or a fruit seed oil, and the probiotic organism is selected from the group consisting of L. Acidophilus, L. Bulgaricus, S. Thermophilus, and B. Bifidum. Where the dehydrated food item is a fruit, particularly preferred fruits include berries and tree fruits, and where the food item is a vegetable, particularly preferred vegetables include broccoli, carrots, celery, and cauliflower (all of which may be comminuted for better ease of handling, bite size preparation, and/or increase in coatable surface). Where the food item is a grain, it is especially preferred that the grain is oat, barley, or wheat (all of which may optionally be rolled, comminuted, or otherwise processed).

Various objects, features, aspects and advantages of the inventive subject matter will become more apparent from the following detailed description of preferred embodiments.

### DETAILED DESCRIPTION

The inventor has discovered that stability of probiotics-fortified food can be substantially improved when dehydrated probiotics are dispersed or otherwise distributed in a non-aqueous and nutritionally acceptable solvent, and when the so prepared mixture is coated over dehydrated food or food with a water activity of equal or less than 0.65. Moreover, such fortified food items have remarkably preserved taste and flavor, even when stored over extended periods.

Most preferably, the dehydrated food item has a water content of less than 5 wt %, more typically less than 4 wt %, and most preferably between 2-3 wt %. Alternatively, and especially where the food has a water content that is equal or greater than 5 wt %, additional agents may be included or coated onto the food that reduce water activity from a value of between about 0.85-0.97 to a value of equal or less than 0.75, more preferably equal or less than 0.7, and most preferably equal or less than 0.65. There are numerous methods and processes of dehydration of food items known in the art, and all of them are suitable for use in conjunction with the teachings herein. However, especially preferred dehydration methods include freeze-drying, drum-drying, and air-drying.

In particularly preferred aspects, the food item is an unprocessed food item that may or may not be cut into small pieces. The term “unprocessed food item” as used herein refers to a food item that is substantially unchanged in its shape and composition. Therefore, berries, fruits, fruit constituents (e.g., flavedo, pulp, etc.), vegetables, roots, etc., as harvested are especially included in the use of the term “unprocessed food item”. Also expressly included are all food items that were infused or otherwise contacted with an agent that reduces water activity (e.g., sugars, non-sugar polyols, glycols, etc.). Also expressly included are all food items that were made from grains and/or grain derivatives that were extruded or formed by mechanical means and then dried to a low moisture. By contrast, food items that are cooked, flavored, and combined with other ingredients to form an edible composition are not within the scope of the meaning of the term “unprocessed food item”.

Especially preferred food items include various grains, fruits and berries, and vegetables, all or which may be comminuted or otherwise rendered into smaller pieces (e.g., to produce bite-sized portions, improve packing or other downstream processing). For example, contemplated grains include oat, wheat, barley, corn, sorghum, millet, rye, or buckwheat, which may be rolled, puffed, cracked, or otherwise comminuted (and optionally reconstituted to a desired shape). In other examples, suitable berries include strawberries, raspberries, boysenberries, blueberries, and cranberries, all of which may be comminuted or otherwise rendered into smaller pieces. Further contemplated fruits especially include tree fruits, and especially apples, apricots, dates, citrus fruits, cherries, mango, and pineapple. Once more such fruit may advantageously be comminuted or otherwise rendered into smaller pieces. Especially preferred vegetables are those that can be eaten in the uncooked state, and therefore include peas, soy beans, broccoli, cauliflower, carrots, celery, cabbage, and peppers, all of which may be comminuted or otherwise rendered into smaller pieces.

Where desired, the comminution or other reduction in size is performed using methods well known in the art, and all of those are deemed suitable for use herein. For example, grains may be coarsely ground, fruits may be cut using appropriately shaped blades, and vegetables may be manually disassembled into smaller pieces. While generally not preferred, the so obtained food item may be further shaped, for example, by pressing or compounding into desired shapes.

The food item is then dehydrated to obtain a dehydrated product that has a residual water content of equal or less than 15 wt %, more typically equal or less than 10 wt %, even more typically equal or less than 5 wt %, and most typically between 1-4 wt %. There are numerous manners of dehydrating food items known in the art, and all of them are deemed suitable for use herein. However, particularly preferred manners will preserve the overall structure of the food item, and most preferably also the color. Therefore, especially preferred manners of dehydration include freeze-drying, vacuum drying, and drum-drying. However, other manners of drying, including hot-air drying, and ultrasound drying are also contemplated.

Alternatively, and especially where the (dehydrated) food items have a residual water content of greater than 5 wt %, suitable dehydration methods may also osmotic drying, and/or combination with agents that reduce water activity, typically from a value of between about 0.97 to 0.85 to a value of equal or less than 0.75, more preferably equal or less than 0.7, and most preferably equal or less than 0.65. For example, suitable agents will include sugars, non-sugar polyols, glycols, all of which are most preferably nutritionally acceptable. Such agents may be coated onto the food item, and/or soaked or injected into the food item.

With respect to probiotic strains it is contemplated that particularly suitable probiotics include Bifidobacterium animalis subsp. Lactis, Bifidobacterium bifidum, Bifidobacterium breve, Bifidobacterium infantis, Bifidobacterium longum, Bacillus coagulans, Lactobacillus acidophilus, Lactobacillus casei, Lactobacillus plantarum, Lactobacillus reuteri, Lactobacillus rhamnosus, Lactobacillus GG, Lactobacillus bulgaricus, and Streptococcus thermophilus. Where the probiotic should include a probiotic yeast, Saccharomyces boulardii and Saccharomyces cerevisiae are especially contemplated. Further suitable probiotic strains are described, for example, in WO 02/076471, which is incorporated by reference herein.

It should further be appreciated that the probiotic culture is prepared following manners and protocols well known in the art. Most typically, the culture is prepared in a non-restricted medium and grown to mid- or late-log phase, or even to a post-log stationary phase. For example, suitable fermentation media include milk and milk-based media (e.g., comprising milk components such as casein, lactoferrin, etc.), especially where the probiotic is a lactobacillus. On the other hand, other nutritionally acceptable fermenting media (e.g., soy-based, grain-based, nut-based) and even synthetic media (e.g., based on mineral salts and yeast autolysates) are also deemed suitable. Depending on the particular desired formulation it is contemplated that the probiotic culture may be heat inactivated, treated with a protease, and/or pasteurized, or that the probiotic culture may be harvested using a protocol that preserves viability. Alternatively, or additionally, probiotic cultures may be selected or enriched such that the final probiotic culture comprises a predetermined quantity of spores.

To retain the low moisture content and/or low water activity, it is generally preferred that the probiotic bacteria are formulated into a dehydrated preparation, and all suitable manners of dehydrating probiotic bacteria are contemplated suitable for use herein. For example, dehydrated probiotic bacteria may be prepared by freeze-drying, or spray-drying, and may further include at least a portion of dried media ingredients. For example, where the probiotics are grown in milk, yoghurt, kefir, etc., it is contemplated that the entire culture is dehydrated. Consequently, the probiotic culture may be admixed with at least a portion of the fermentation medium. Additionally, or alternatively, a culture containing one or more probiotic bacterial species may also be harvested at a desired density and resuspended in an appropriate solvent (which may or may not include suitable nutrients [e.g., inulin]). The so prepared formulation is then dehydrated to a desired degree (typically to complete dryness at less than 5 wt % residual water).

In further particularly preferred aspects of the inventive subject matter, the so dehydrated probiotic microorganisms (and optional media components or medium) are then dispersed in or otherwise combined with a non-aqueous and nutritionally acceptable solvent to a desired concentration to form a coating medium. For example, suitable probiotic cell concentrations may be between 10⁴ to 10¹² cfu/ml. Among other suitable solvents, nutritionally acceptable solvents, and especially vegetable oils, glycerol, various glycols, omega-3 oils, and fruit seed oils, are particularly preferred. Further suitable solvents include those described in WO 02/060510, which is incorporated by reference herein.

Where desired, the solvent may also include additional compounds that improve a physical and/or subjective parameter. For example, the solvent may include various anti-oxidants, colorants, and/or flavors, or may include thickeners. The so obtained coating solution is then sprayed, dip-coated, or otherwise applied onto the dehydrated food item to form a coated and/or impregnated dehydrated food item. It should be especially appreciated that the non-aqueous coating will not change the color, flavor, or any other sensory aspect of the dehydrated food item. Therefore, it should be appreciated that using contemplated compositions and methods, a probiotic-fortified dehydrated food can be prepared that will have between 10⁴-10¹⁰ cfu/gram of food item, wherein the shelf life of such probiotics is typically at least several weeks, and more typically at least several months (i.e., loss of cfu/week or month less than 50%, wherein week or month is between 1 and 24). While not limiting to the inventive subject matter, it is contemplated that the coating solution will at least partially soak into the dehydrated food item and so become less susceptible to oxidation and other degradation.

Depending on the type of application of the coating solution, it should be recognized that the amount of coating solution and probiotic organisms may vary considerably. In most typical examples, the weight ratio of the coating solution to the dehydrated food item will be in the range of between 0.001:1 to 10:1, and more typically between 0.01:1 to 1:1. Especially preferred ratios are 0.01:1 to 0.1:1. Therefore, the total probiotic content will typically be at least 10⁴ cfu/gram of the food item, and more typically at least 10⁶ cfu/gram of the food item.

Where the food item is relatively impervious to fluids, it is contemplated that the food item may be modified such as to increase the uptake of the coating solution. Therefore, and especially where the food item is a grain, seed, or nut, the food item may be cracked, puffed, flaked, extruded, or otherwise treated such that the surface are is increased relative to the starting material. As before, and regardless of the manner of treatment, it is contemplated that such food item will have a water content of equal or less than 5 wt % or a water activity of equal or less than 0.65. Once the food item is treated and dehydrated, a coating solution is then applied to the item in an amount sufficient to achieve a total probiotic content of at least 10⁵ cfu/gram and more preferably at least 10⁶ cfu/gram.

Therefore, particularly preferred methods of fortifying a food item will include a step of providing an unprocessed grain, fruit, or vegetable, or portion thereof and dehydrating the grain, fruit, or vegetable, or portion thereof to a water content of equal or less than 5 wt % or to a water activity of equal or less than 0.65. Alternatively, an already dehydrated food item may be used in conjunction with the methods and compositions presented herein. Most typically, preferred methods will include a further step of preparing a fermentation medium and/or fermenting one or more probiotic organisms. Once fermented, the composition comprising the probiotic organism is dehydrated (or such composition is acquired) and combined with a non-aqueous (water content less than 5 wt %) and nutritionally acceptable solvent to thereby form a coating suspension. This suspension and/or solvent may be further modified with suitable ingredients (e.g., one or more prebiotic, vitamin, mineral, etc.) and is then applied to the food item in numerous manners.

Most typically, application of the coating agent in performed by a spray and/or dip-coating process, by immersion for a predetermined period (typically between 10 seconds and 5 minutes), or by infusion. Where desired, the so coated food item is then allowed to rest to produce a coated item that is dry to the touch and will not aggregate upon storage. With respect to the final concentration of probiotic organisms, the same considerations as provided above apply. Thus, it should be particularly recognized that food items can be prepared in which the exceptional advantages of unprocessed food are combined with the desirable properties of probiotics.

In still further contemplated aspects, it should be appreciated that the coated food item may be compounded into a wide variety of edible products, including snack bars, functional food, dietary supplement products. Therefore, and among other suitable products it is contemplated that the dehydrated and fortified food items can be incorporated into very low moisture (less than 10-15 wt % water content) food items such as cereals, snack mixes, baby food, etc., or that they can be consumed as prepared.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A dehydrated and unprocessed food item selected from the group consisting of a grain, a fruit, and a vegetable, or a portion thereof, at least partially coated with a non-aqueous and nutritionally acceptable solvent that comprises a probiotic organism at a concentration sufficient to achieve a total probiotic content of at least 10⁴ cfu/gram of the food item.

2. The food item of claim 1 wherein the fruit is an optionally comminuted berry or an optionally comminuted tree fruit.

3. The food item of claim 1 wherein the vegetable is an optionally comminuted broccoli, an optionally comminuted carrot, an optionally comminuted celery, or optionally comminuted cauliflower.

4. The food item of claim 1 wherein the grain is an optionally comminuted or rolled oat, an optionally comminuted or rolled barley, or an optionally comminuted or rolled wheat.

5. The food item of claim 1 wherein the grain, fruit, vegetable, or portion thereof is dehydrated to have a water content of equal or less than 5 wt % or to have a water activity of equal or less than 0.65.

6. The food item of claim 5 wherein the probiotic organism is dehydrated.

7. The food item of claim 1 wherein the probiotic organism is dehydrated.

8. The food item of claim 1 wherein the nutritionally acceptable solvent is selected from the group consisting of a vegetable oil, glycerol, a glycol, an omega-3 oil, and a fruit seed oil.

9. The food item of claim 1 wherein the probiotic organism is selected from the group consisting of L. Acidophilus, L. Bulgaricus, S. Thermophilus, and B. Bifidum.

10. The food item of claim 1 wherein the solvent further comprises a milk product that is producible by the probiotic organism.

11. The food item of claim 1 wherein the milk product is dehydrated.

12. The food item of claim 1 wherein the grain, fruit, or vegetable, or portion thereof is a freeze-dried grain, fruit, or vegetable, or portion thereof.

13. The food item of claim 1 wherein the probiotic organism is present at a concentration sufficient to achieve a total probiotic content of at least 10⁶ cfu/gram.

14. A dehydrated grain product, at least partially coated with a non-aqueous and nutritionally acceptable solvent that comprises a probiotic organism at a concentration sufficient to achieve a total probiotic content of at least 10⁵ cfu/gram of the grain product, wherein the grain product is dehydrated to have a water content of equal or less than 5 wt % or to have a water activity of equal or less than 0.65.

15. The dehydrated grain product of claim 14 wherein the nutritionally acceptable solvent is selected from the group consisting of a vegetable oil, glycerol, a glycol, an omega-3 oil, and a fruit seed oil, and wherein the probiotic organism is selected from the group consisting of L. Acidophilus, L. Bulgaricus, S. Thermophilus, and B. Bifidum.

16. A method of fortifying a food item, comprising:
providing an unprocessed grain, fruit, or vegetable, or portion thereof and dehydrating the grain, fruit, or vegetable, or portion thereof to a water content of equal or less than 5 wt % or to a water activity of equal or less than 0.65;
dehydrating a composition comprising a probiotic organism and combining the probiotic organism with a non-aqueous and nutritionally acceptable solvent to thereby form a coating suspension; and
coating the grain, fruit, or vegetable, or portion thereof with the coating suspension.

17. The method of claim 16 wherein the fruit is an optionally comminuted berry or an optionally comminuted tree fruit.

18. The method of claim 16 wherein the vegetable is an optionally comminuted broccoli, an optionally comminuted carrot, an optionally comminuted celery, or optionally comminuted cauliflower.

19. The method of claim 16 wherein the grain is optionally comminuted or rolled oat, optionally comminuted or rolled barley, or optionally comminuted or rolled wheat.

20. The method of claim 16 wherein the nutritionally acceptable solvent is selected from the group consisting of a vegetable oil, glycerol, a glycol, an omega-3 oil, and a fruit seed oil, and wherein the probiotic organism is selected from the group consisting of L. Acidophilus, L. Bulgaricus, S. Thermophilus, and B. Bifidum.
